(19) United States
(12) Patent Application Publication
(10) Pub. No.: US 2016/0052221 A1
(43) Pub. Date: Feb. 25, 2016

(54) Eco Press

(71) Applicant: Mike Brostrom, Duluth, MN (US)

(72) Inventor: Mike Brostrom, Duluth, MN (US)

(21) Appl. No.: 14/466,414

(22) Filed: Aug. 22, 2014

(51) Int. Cl. B30B 9/06; B30B 1/04; C10L 5/44

(52) U.S. Cl. CPC B30B 9/065; C10L 5/44; B30B 1/04

(57) ABSTRACT

The invention is a metal hand press that compresses certain biomass materials into a briquette that can be used as a heat, fuel, or fire source. The process starts by soaking biomass materials with water, preferably shredded paper waste, sawdust, or coffee grounds. The soaked material is then placed into the biomass press and compacted using a lever and press plate. Water drains out the baseplate perforations and flows down the channel to the ground or a collection chamber. The press handle is raised and the removable basket comes out of the press, where the compacted briquette can be retrieved and set aside to dry for later use.

### BACKGROUND OF THE INVENTION

The present invention provides a method for an efficient way to turn certain waste biomass products using a hand press into a solid briquette for home heating, cooking, or fireplace use.

The terms “biomass briquette”, “fuel briquette” and “briquette” are used interchangeable in this literature.

U.S. Pat. No. 4,461,626, issued to Foldbjerg in 1984, describes a wet paper press that produces a long; thick compressed paper log. This particular press uses a removable press plate where the soaked paper is placed into the basket and then two levers that cross over each other are compressed in a downward motion to remove the water from the paper. The levers are then reversed, the press plate removed, and finally the basket is removed from the press in order to retrieve the log.

One disadvantage with the operation of U.S. Pat. No. 4,461,626 is that only a limited amount of compression can be achieved since the operator must stand over the press and obtain only a small amount of leverage. The bars of the press are very thin and often cause operator fatigue and soreness of the hand. Lastly, due to the large size and thickness of the finished paper log, drying times are significant.

Paper waste can account for nearly 30% of the overall waste that American's throw away each year. With the average family receiving about 1.5 pounds of junk mail each day, there is a clear need for responsible ways to deal with this waste. Home heating costs in the United States were as much as 40% higher in 2013 than in 2012 in many areas of the Midwest. A propane shortage left some customers without their primary heating source for a period of time over one of the coldest winters in recent history. Supplemental heating with wood is a popular alternative in the United States to burning fossil fuels for heat. Many homeowners also enjoy the glow and warmth a fireplace provides during the cooler months.

Some third world countries have used compressed biomass materials for heating or cooking for many years. Deforestation is a major concern in many areas of the world and alternatives to traditional wood fuel are important to conserve forests across the world. Most third world paper presses are made out of wood, can be extremely large in size, and are not able to produce a desirable output of finished briquettes in a short period of time. Since many of these presses are made out of wood, they are prone to expansion as the wood gets wet, thus making tolerances within the machine not very accurate.

American's consume nearly 12 million pounds of coffee annually. The spent coffee grounds are a major contributor to landfill waste and the need increases to find a way to recycle spent coffee grounds. Many peer reviewed journal articles support the fact that coffee grounds can provide more BTU heating value than wood and even some fossil fuel sources.

The transportation of firewood has become highly regulated, if allowed at all, in some areas of the United States over the concern of invasive species. The Emerald Ash Borer and Gypsy Moth are two exotic invasive species that have decimated timber stands in certain areas of the Midwest. Due to the high risk of introducing these exotic species into more areas, transportation of wood (firewood) has been sanctioned, or outright banned. The present invention offers a convenient way for hikers, backpackers and campers to transport combustible briquettes that take up little space but can provide around 45 minutes of burn time from one briquette.

### SUMMARY OF THE INVENTION

The invention is a metal press that takes certain water soaked biomass materials and compresses them into combustible briquettes for later use. The press drains water from the biomass through perforations in the basket and press plate down to the base plate, where the water can be recycled again or drained to the ground. The briquette basket is then removed from the press and the briquette is retrieved and placed in a suitable area to dry; later to be used as heating, fuel, or fire source. The invention is then ready to produce another briquette and the process can be repeated. Wet briquetting in this form requires no electricity or burning of fossil fuels, unlike high heat and compression automated hydraulic machines.

### BRIEF DESCRIPTION OF THE DRAWINGS

FIG. 1 is a complete exploded drawing of the biomass briquette press invention.

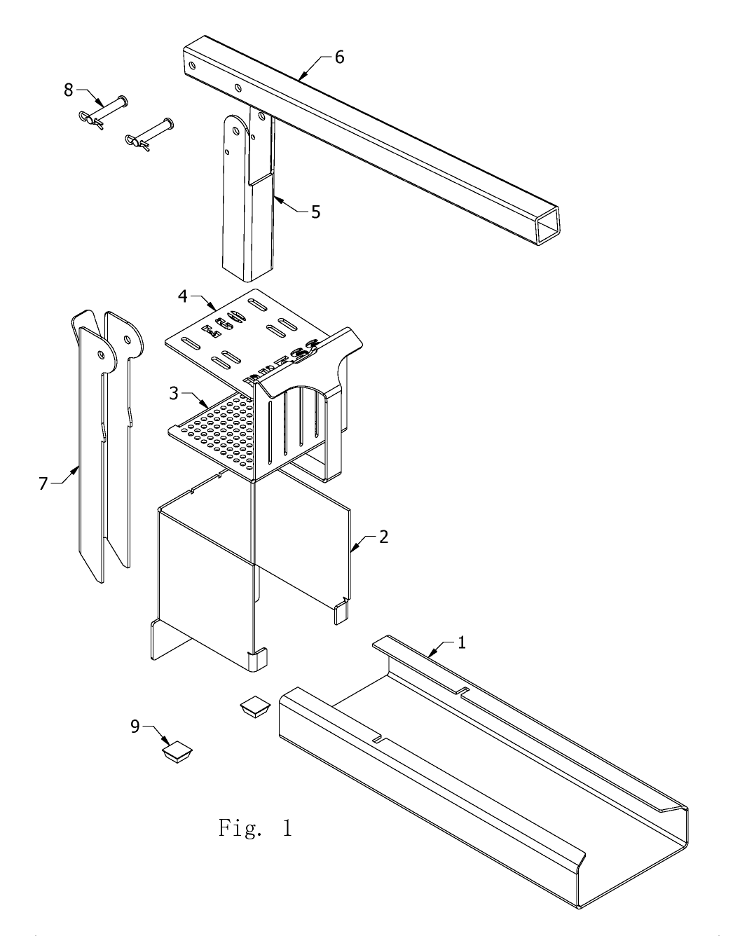

Within FIG. 1:

ITEM 1 is the base plate which provides the support platform and allows the water from the compressed biomass materials to drain onto the ground, or in a collection container placed below.

ITEM 2 is the box which contains the biomass material and helps shape it into a briquette.

ITEM 3 is the basket which contains the biomass material and allows the water to drain through the perforations in the bottom and side. The basket also contains the handle which the operator uses to remove the basket from the box, and the finished briquette from the basket.

ITEM 4 is the press plate which is welded to the piston arm and has slits cut in to allow water to drain out the top of the plate and then through the basket.

ITEM 5 is the piston arm, which is welded to the press plate and clevis pinned to the press arm.

ITEM 6 is the press arm which provides the leverage and compression for making the briquette.

ITEM 7 is the vertical support stanchion that secures the press arm with a clevis pin, and is welded to the back of the box and base plate.

ITEM 8 are the two clevis pins that secure both the press arm to the stanchion and the piston arm to the lever arm.

ITEM 9 are the two rubber feet that provide elevation for the press to allow gravity to assist in draining water down the base plate.

### DETAILED DESCRIPTION OF THE INVENTION

The invention is a metal hand press that compresses certain biomass materials into a briquette that can be used as a heat, fuel, or fire source. The press is constructed out of steel sheet, which is cut using a computer controlled water cutting machine for precise accuracy. The water drainage perforations cut into ITEM 3, FIG. 1, are large enough to allow water to flow out of the basket, but small enough that biomass particles do not escape. The tight drainage perforations allow for proper compaction, which is important to allow the finished briquette to hold its shape and remain sturdy. The steel sheets are then bent using a computer controlled press brake.

ITEMS 1, 2, 4, 5 & 7 are all welded together for strength. ITEMS 5, 6 and 7 also use clevis pins to make them easy to remove for servicing and allow access to the moving parts of the press. A primer and paint coat are applied for aesthetic reasons and corrosion resistance.

The briquette press is designed to be placed on a tabletop, work bench, or it can also be used on a suitable stable surface on the ground. The rear of the press is slightly elevated to allow the discharged water to gravity drain out of the open front end of the press, where the water can be collected and recycled, or simply drained into the ground.

Once the press is placed on a stable platform, ITEM 6 is raised to its maximum height where it is self-supporting and rests in place on the top tab of ITEM 7.

Preferred materials for use in the press can include mixtures of shredded paper waste, sawdust, or coffee grounds. Shredded paper and sawdust may provide around half of the total mixture to ensure sufficient binding of the finished briquette. The soaked biomass materials are then scooped from a holding bucket and placed inside ITEM 2, resting on top of ITEM 3.

ITEM 6 is then lowered by hand which pushes ITEM 4 and ITEM 5 downward, which compacts the biomass materials and forces water through the drainage perforations, and out the open end of the base plate. The compaction is held for a brief period of time to allow the majority of the water to drain from the biomass material. The compaction leverage ratio is 2:15.

ITEM 6 is then raised to its maximum height, where it rests on the tab of ITEM 7, and then ITEM 3 can be removed from the press. The finished briquette can then be removed from ITEM 3 and set aside in a suitable area to dry. ITEM 3 is then placed back inside of ITEM 2 and the process can be repeated.

The advantages to the present invention are numerous. The present invention is self-supporting and could be operated with one hand, if desired. The press arm is also self-supporting and will keep the press plate in the open position to allow easy loading of the box/basket area. When leverage is applied, the hand grip provides operator cushioning and high compression leverage. The raised rear angle of the invention assists gravity in automatically draining the water from the basket, box and press plate to the ground, or a container for recycling. The basket is easy to remove and allows for efficient briquette removal so the process can be replicated over again.

The invention claimed is:

1. A metal biomass hand lever press that is capable of receiving a water soaked biomass material and compressing it into a briquette that can later be used as a heat, fuel, or fire source.

2. The components and material of the press in claim 1 are strong enough to withstand compaction forces to extrude the majority of the water from the biomass material.

3. The press from claim 1 can use a variety of biomass materials in the proper shape and size, once soaked with water, so that they may be compacted into the shape of a briquette.

4. The press from claim 1 has a press arm, piston arm, and a press plate that supports itself in an upright position to allow the basket chamber to be filled with a suitable biomass material for compaction.

5. The press from claim 1 has sufficient drainage perforations to allow the compressed biomass material to drain water from the basket where it is discharged down the baseplate to the ground or a collection container.

6. The press from claim 1 has an easy to remove basket where the finished briquette can be removed quickly and the basket re-inserted into the press for the next briquette.

7. The press from claim 1 is slightly elevated at the rear of the press to allow the discharged water to gravity drain down the press base plate to the ground, or a collection container.
